(19) United States
(12) Patent Application Publication
(10) Pub. No.: US 2020/0231905 A1
(43) Pub. Date: Jul. 23, 2020

(54) POWDER LAUNDRY DETERGENT FORMULATION

(71) Applicant: Dow Global Technologies LLC, Midland, MI (US)

(72) Inventors: Saugata Nad, Auderghem (BE); Ashish G. Muratkar, Thane (IN)

(21) Appl. No.: 16/639,141

(22) PCT Filed: Aug. 7, 2018
(86) PCT No.: PCT/US2018/045475

§ 371 Date: Feb. 14, 2020

(30) Foreign Application Priority Data
Sep. 4, 2017 (IN) 201741031240

(51) Int. Cl. C11D 3/37; C11D 1/22; C11D 3/00; C11D 11/00; C11D 17/06

(52) U.S. Cl. CPC C11D 3/3761; C11D 3/3707; C11D 17/06; C11D 3/0094; C11D 11/0017; C11D 1/22

(57) ABSTRACT

A powder laundry detergent formulation is provided having a detergent surfactant; a builder; a polyethylene oxide having a weight average molecular weight, Mw, of 750,000 Daltons to 10,000,000; and a poly(acrylic acid) having a weight average molecular weight, Mw, of 1,000 to 20,000.

The present invention relates to a powder laundry detergent formulation. In particular, the present invention relates to a powder laundry detergent formulation having a detergent surfactant; a builder; a polyethylene oxide having a weight average molecular weight, Mw, of 750,000 Daltons to 10,000,000; and a poly(acrylic acid) having a weight average molecular weight, Mw, of 1,000 to 20,000.

Despite the increased use of automatic laundry machines, the handwashing of textiles remains prevalent in many locals. Accordingly, there is a continuing need for improved powder laundry formulations containing surfactant.

Consumers that use powder laundry formulations for hand washing textiles, typically view suds formation as a primary indicator of the cleaning effectiveness of a given formulation. Thus, high suds volume is considered desirable by consumers. Nevertheless, it is expensive to add more surfactant to detergents, simply to improve the suds formation and stability.

An approach to enhancing suds performance in laundry detergent formulations is disclosed in United States Patent Application Publication No. 20140366271 to Mort, et al. Mort et al. disclose a granular detergent composition comprising from 1% to 99% by total weight of said composition of structured particles that comprise: (1) from 35% to 80% of an anionic surfactant by total weight of the structured particles; and 2) from 8% to 50% of a hydrophilic silica by total weight of the structured particles, wherein said structured particles are characterized by a particle size distribution Dw50 ranging from 250 pm to 1000 um and a bulk density ranging from 500 to 1000 g/L, wherein said anionic surfactant is a C₁₀₋₂₀ linear or branched alkylethoxy sulfate or salt thereof having an average degree of ethoxylation ranging from 0.1 to 5.0, wherein said hydrophilic silica comprises less than 10% residual salt by total weight of the silica and is capable of forming swollen silica particles upon hydration, and wherein said swollen silica particles have a particle size distribution Dv50 of from 1 pm to 100 pm.

Therefore, there is a continuing need for powder laundry formulations that are capable of generating more suds during the wash, but without increasing the amount of surfactant in the formulation.

The present invention provides a powder laundry detergent formulation, comprising: 5 to 50 wt % of a detergent surfactant; 25 to 80 wt % of a builder; and 0.01 to 1 wt % of a polyethylene oxide having a weight average molecular weight, Mw, of 750,000 Daltons to 10,000,000; 0.01 to 5 wt % of a poly(acrylic acid) having a weight average molecular weight, Mw, of 1,000 to 20,000.

The present invention provides a method of cleaning a textile, comprising: providing a textile; providing a wash water; providing a rinse water; providing a powder laundry detergent of the present invention; mixing the powder laundry detergent and the wash water to form a laundry liquor; treating the textile with the laundry liquor; and rinsing the textile with the rinse water.

### DETAILED DESCRIPTION

We have now found that a powder laundry detergent formulation including a blend of a polyethylene oxide having a weight average molecular weight, Mw, of 750,000 to 10,000,000 Daltons and a poly(acrylic acid having a weight average molecular weight, Mw, of 1,000 to 20,000 Daltons has improved foam volume and stability.

Unless otherwise indicated, ratios, percentages, parts, and the like are by weight.

As used herein, unless otherwise indicated, the phrase “molecular weight” or Mw refers to the weight average molecular weight as measured in a conventional manner with gel permeation chromatography (GPC) and poly(ethylene oxide) standards. GPC techniques are discussed in detail in Modem Size Exclusion Chromatography, W. W. Yau, J. J. Kirkland, D. D. Bly; Wiley-lnterscience, 1979, and in A Guide to Materials Characterization and Chemical Analysis, J. P. Sibilia; VCH, 1988, p. 81-84. Molecular weights are reported herein in units of Daltons.

Operations described herein were performed at room temperature (20-25° C.), unless specified otherwise.

Preferably, the powder laundry detergent formulation of the present invention, comprises: 5 to 50 wt % (preferably, 7.5 to 30 wt %; more preferably, 10 to 25 wt %; most preferably, 14 to 20 wt %) of a detergent surfactant; 25 to 80 wt % (preferably, 30 to 75 wt %; more preferably, 35 to 70; most preferably, 40 to 65 wt %) of a builder; 0.01 to 1 wt % (preferably, ≥0.05 wt %; more preferably, ≥0.07 wt %; still more preferably, ≥0.09 wt %; preferably, ≤0.8 wt %; more preferably, ≤0.6 wt %; most preferably, ≤0.5 wt %) of a polyethylene oxide having a weight average molecular weight, Mw, of 750,000 Daltons to 10,000,000 (preferably, ≥1,000,000; more preferably, ≥2,000,000; still more preferably, ≥4,000,000; preferably, ≤8,000,000; more preferably, ≤7,000,000; most preferably, ≤6,000,000); and 0.01 to 5 wt % (preferably, ≥0.1 wt %; more preferably, ≥0.5 wt %; still more preferably, ≥0.75 wt %; preferably, ≤4 wt %; more preferably, ≤3 wt %; still more preferably, ≤2 wt %; most preferably, ≤1.5 wt %) of a poly(acrylic acid) having a weight average molecular weight, Mw, of 1,000 to 20,000 (preferably, ≥1,500; more preferably, ≥2,500; still more preferably, ≥3,000; preferably, ≤15,000; more preferably, ≤10,000; still more preferably, ≤7,000; most preferably, ≤6,000).

Preferably, the powder laundry detergent formulation of the present invention comprises 5 to 50 wt % of a detergent surfactant. More preferably, the powder laundry detergent formulation of the present invention, comprises 7.5 to 30 wt % of a detergent surfactant. Still more preferably, the powder laundry detergent formulation of the present invention comprises 10 to 25 wt % of a detergent surfactant. Most preferably, the powder laundry detergent formulation of the present invention comprises 14 to 20 wt % of a detergent surfactant.

Preferable, the powder laundry detergent formulation of the present invention comprises ≥5 wt % (preferably, ≥7.5 wt %; more preferably, ≥10 wt %; most preferably, ≥14 wt %) of a detergent surfactant.

Preferably, the powder laundry detergent formulation of the present invention comprises ≤50 wt % (preferably, ≤30 wt %; more preferably, ≤25 wt %; most preferably, ≤20 wt %) of a detergent surfactant.

Preferably, the detergent surfactant used in the powder laundry detergent formulation of the present invention is selected from the group consisting of anionic surfactants, nonionic surfactants, zwitterionic surfactants, ampholytic surfactants, cationic surfactants and mixtures thereof. More preferably, the detergent surfactant used in the powder laundry detergent formulation of the present invention includes a surfactant selected from the group consisting of an alkylbenzenesulfonate, an alcohol sulfate, an alcohol ethoxylate. Most preferably, the detergent surfactant used in the powder laundry detergent formulation of the present invention includes an anionic surfactant. Preferably, the anionic surfactant is selected from the group consisting of an alkylbenzenesulfonate, a fatty alcohol ether sulfate and mixtures thereof. Preferably, the anionic surfactant includes an alkylbenzenesulfonate. More preferably, the anionic surfactant includes a linear alkylbenzenesulfonate. Most preferably, the anionic surfactant includes a linear C₁₀₋₂₀ alkylbenzenesulfonate.

Preferably, the powder laundry detergent formulation of the present invention comprises 25 to 80 wt % of a builder. More preferably, the powder laundry detergent formulation of the present invention, comprises 30 to 75 wt % of a builder. Still more preferably, the powder laundry detergent formulation of the present invention comprises 35 to 70 wt % of a builder. Most preferably, the powder laundry detergent formulation of the present invention comprises 40 to 65 wt % of a builder.

Preferably, the powder laundry detergent formulation of the present invention comprises ≥25 wt % (preferably, ≥30 wt %; more preferably, ≥35 wt %; most preferably, ≥40 wt %) of a builder.

Preferably, the powder laundry detergent formulation of the present invention comprises ≤80 wt % (preferably, ≤75 wt %; more preferably, ≤70 wt %; most preferably, ≤65 wt %) of a builder.

Preferably, the builder used in the powder laundry detergent formulation of the present invention is selected from organic and inorganic materials conventionally used as builders in powder laundry detergents. Preferably, the builder used in the powder laundry detergent formulation of the present invention is selected from the group consisting of hydratable alkali metal phosphates, alkali metal carbonates (including carbonates and bicarbonates), zeolites, ethylenediaminetetraacetate, nitrilotriacetate and mixtures thereof. More preferably, the builder used in the powder laundry detergent formulation of the present invention includes at least one of zeolite, sodium triphosphate, sodium tripolyphosphate, sodium citrate, sodium silicate, sodium carbonate, calcium carbonate, sodium bicarbonate and calcium bicarbonate. Most preferably, the builder used in the powder laundry detergent formulation of the present invention includes at least one of zeolite, sodium tripolyphosphate, sodium carbonate and calcium carbonate.

Preferably, the powder laundry detergent formulation of the present invention comprises 0.01 to 1 wt % of a polyethylene oxide having a weight average molecular weight, Mw, of 750,000 Daltons to 10,000,000 (preferably, ≥1,000,000; more preferably, ≥2,000,000; still more preferably, ≥4,000,000; preferably, ≤8,000,000; more preferably, ≤7,000,000; most preferably, ≤6,000,000).

Preferably, the powder laundry detergent formulation of the present invention comprises ≥0.01 wt % (preferably, ≥0.05 wt %; more preferably, ≥0.07 wt %; most preferably, ≥0.09 wt %) of a polyethylene oxide having a weight average molecular weight, Mw, of 750,000 Daltons to 10,000,000 (preferably, ≥1,000,000; more preferably, ≥2,000,000; still more preferably, ≥4,000,000; preferably, ≤8,000,000; more preferably, ≤7,000,000; most preferably, ≤6,000,000).

Preferably, the powder laundry detergent formulation of the present invention comprises ≤1 wt % (preferably, ≤0.8 wt %; more preferably, ≤0.6 wt %; most preferably, ≤0.5 wt %) of a polyethylene oxide.

Preferably, the polyethylene oxide used in the powder laundry detergent formulation of the present invention has a weight average molecular weight, Mw, of ≥750,000 (preferably, ≥1,000,000; more preferably, ≥2,000,000; still more preferably, ≥4,000,000) Daltons.

Preferably, the polyethylene oxide used in the powder laundry detergent formulation of the present invention has a weight average molecular weight, Mw, of ≤10,000,000 (preferably, ≤8,000,000; more preferably, ≤7,000,000; most preferably, ≤6,000,000) Daltons.

Preferably, the powder laundry detergent formulation of the present invention comprises 0.01 to 5 wt % of a poly(acrylic acid) having a weight average molecular weight, Mw, of 1,000 to 20,000 (preferably, ≥1,500; more preferably, ≥2,500; still more preferably, ≥3,000; preferably, ≤15,000; more preferably, ≤10,000; still more preferably, ≤7,000; most preferably, ≤6,000).

Preferably, the powder laundry detergent formulation of the present invention comprises ≥0.01 wt % (preferably, ≥0.1 wt %; more preferably, ≥0.5 wt %; most preferably, ≥0.75 wt %) of a poly(acrylic acid) having a weight average molecular weight,Mw, of 1,000 to 20,000 (preferably, ≥1,500; more preferably, ≥2,500; still more preferably, ≥3,000; preferably, ≤15,000; more preferably, ≤10,000; still more preferably, ≤7,000; most preferably, ≤6,000).

Preferably, the powder laundry detergent formulation of the present invention comprises ≤5 wt % (preferably, ≤4 wt %; more preferably, ≤3 wt %; still more preferably, ≤2 wt %; most preferably, ≤1.5 wt %) of a poly(acrylic acid) having a weight average molecular weight, Mw, of 1,000 to 20,000 (preferably, ≥1,500; more preferably, ≥2,500; still more preferably, ≥3,000; preferably, ≤15,000; more preferably, ≤10,000; still more preferably, ≤7,000; most preferably, ≤6,000).

Preferably, the poly(acrylic acid) used in the powder laundry detergent formulation of the present invention has a weight average molecular weight, Mw, of ≥1,000 (preferably, ≥1,500; more preferably, ≥2,500; most preferably, ≥3,000) Daltons.

Preferably, the poly(acrylic acid) used in the powder laundry detergent formulation of the present invention has a weight average molecular weight, Mw, of ≤20,000 (preferably, ≤15,000; more preferably, ≤10,000; still more preferably, ≤7,000; most preferably, ≤6,000) Daltons.

Preferably, the powder laundry detergent formulation of the present invention, further comprises one or more optional ingredients selected from the group consisting of bleaching agents, bleach activators, antiredeposition agents, stabilizers, foam regulators, enzymes, optical brighteners, fillers, processing aids and fragrances.

Preferably, the powder laundry detergent formulation of the present invention, further comprises 0 to 10 wt % of a bleaching agent. Preferred bleaching agents include, for example, sodium perborate and sodium percarbonate.

Preferably, the powder laundry detergent formulation of the present invention, further comprises 0 to 10 wt % of a bleach activator. Preferred bleach activators include, for example, tetra acetyl ethylene diamine (TAED) and sodium nonanoyloxybenzene sulfonate (NOBS).

Preferably, the powder laundry detergent formulation of the present invention, further comprises 0 to 2 wt % of an antiredeposition agent. Preferred antiredeposition agents include, for example, carboxymethylcellulose and cellulose ether.

Preferably, the powder laundry detergent formulation of the present invention, further comprises 0 to 1 wt % of a stabilizer. Preferred stabilizers include, for example, phosphonates.

Preferably, the powder laundry detergent formulation of the present invention, further comprises 0 to 2 wt % of an enzyme. Preferred enzymes include, for example, protease, cellulase, amylase and lipase.

Preferably, the powder laundry detergent formulation of the present invention, further comprises 0 to 0.3 wt % of an optical brightener. Preferred optical brighteners include, for example, fluorescent whitening agents.

Preferably, the powder laundry detergent formulation of the present invention, further comprises 0 to 50 wt % (preferably, 5 to 40 wt %; more preferably, 10 to 35 wt %; 20 to 35 wt %) of a filler. Preferred fillers include, for example, sodium sulfate and sodium chloride.

Preferably, the powder laundry detergent formulation of the present invention may be produced by well known manufacturing methods. For example, the powder detergent formulation of the present invention may be produced using techniques including spray drying of various combinations of the components.

Preferably, the method of cleaning a textile of the present invention, comprises: providing a textile; providing a wash water; providing a rinse water; providing a powder laundry detergent of the present invention; mixing the powder laundry detergent and the wash water to form a laundry liquor; treating the textile with the laundry liquor; and rinsing the textile with the rinse water.

Preferably, in the method of cleaning a textile of the present invention, the textile is treated with the laundry liquor by using well known hand washing techniques. Preferably, the powder laundry detergent is mixed with the wash water at a weight ratio of powder laundry detergent to wash water of 1:100 to 1:1,000.

Some embodiments of the present invention will now be described in detail in the following Examples.

TABLE 1
Base Detergent Composition

| Ingredient | (wt %) |
|---|---|
| Linear alkyl benzene sulfonate | 14-20 |
| Sodium tripolyphosphate | 7-10 |
| Soda Ash Light (Sod Carbonate) | 25-35 |
| Whitening agent¹ | 0.07 |
| Speckle-Soda-Orange | 0.5 |
| Speckle-Soda-Ultra Marine Coated | 0.5 |
| Zeolite | 7-10 |
| Sodium Sulphate | 5-10 |
| Perfume Rose and Jasmine | 0.6 |
| Folcal U-Ppt. Calcium carbonate | 2-8 |
| Dolomite | 2-6 |
| NaCl | Balance |

### COMPARATIVE EXAMPLES C1-C4 and EXAMPLES 1-2

### Laundry Detergent Composition

Powder laundry detergent formulations were prepared in each of Comparative Examples C1-C4 and Examples 1-2 having the composition set forth in TABLE 2.

TABLE 2

| | (wt %) | | | | | |
|---|---|---|---|---|---|---|
| Ingredient | C1 | C2 | C3 | C4 | 1 | 2 |
| Base Detergent Composition | 100 | 99 | 99 | 99 | 99 | 99.7 |
| Poly(acrylic acid)² | — | 0.9 | 0.9 | — | 0.9 | 0.27 |
| Polyethylene oxide³ | — | — | — | 0.1 | 0.1 | 0.03 |
| Polyethylene oxide⁴ | — | 0.1 | — | — | — | — |
| Polyethylene oxide⁵ | — | — | 0.1 | — | — | — |
| Dispersant polymer⁶ | — | — | — | 0.9 | — | — |

¹ Tinopal CBSX fluorescent whitening agent
²Acusol ® 445G poly(acrylic acid) homopolymer having a weight average molecular weight, M_{W}, of 4,500 Daltons available from The Dow Chemical Company
³Polyox ® WSR coagulant polyethylene oxide having a weight average molecular weight, M_{W}, of 5,000,000 Daltons available from The Dow Chemical Company
⁴PEG 400 polyethylene glycol having a number average molecular weight, M_{N}, of 400 Daltons available from Sigma-Aldrich
⁵Polyox ® WSR N-10 polyethylene oxide having a weight average molecular weight of 100,000 Daltons available from The Dow Chemical Company
⁶Acusol ® 588G sulfonated dispersant polymer available from The Dow Chemical Company

### Detergent Testing

Foam test protocol:
Prepare test solution containing 0.3 wt % of the laundry detergent composition in water
Transfer 50 mL of the test solution to a 250 mL graduated glass cylinder with a lid
Shake the cylinder in foam measuring apparatus with 360 degree rotation for 30 seconds at 30 rpm then place cylinder on a flat surface
Wait 30 seconds for aqueous layer to separate
Turn cylinder upside down once to even out the foam level
Immediately measure foam height in cylinder (in mm)—this is the Initial Foam volume at time=0 minutes
Measure the foam height again at t=5 mins, 10 mins, 15 mins and 20 mins

The results of the foam test protocol for the laundry detergent compositions for Comparative Examples C1-C4 and Examples 1-2 are reported in TABLE 3.

TABLE 3

| | Foam height (mm) at time | | | | |
|---|---|---|---|---|---|
| Detergent Composition | 0 min | 5 min | 10 min | 15 min | 20 min |
| Comparative Example C1 | 160 | 155 | 145 | 135 | 130 |
| Comparative Example C2 | 150 | 140 | 130 | 125 | 120 |
| Comparative Example C3 | 155 | 150 | 145 | 130 | 130 |
| Comparative Example C4 | 185 | 180 | 175 | 170 | 170 |
| Example 1 | 190 | 185 | 185 | 180 | 180 |
| Example 2 | 180 | 175 | 170 | 165 | 165 |

We claim:

1. A powder laundry detergent formulation, comprising:
5 to 50 wt % of a detergent surfactant;
25 to 80 wt % of a builder;
0.01 to 1 wt % of a polyethylene oxide having a weight average molecular weight, Mw, of 750,000 Daltons to 10,000,000; and 0.01 to 5 wt % of a poly(acrylic acid) having a weight average molecular weight, Mw, of 1,000 to 20,000.

2. The powder laundry detergent formulation of claim 1, containing 0.05 to 0.5 wt % of the polyethylene oxide having a weight average molecular weight, Mw, of 2,000,000 to 8,000,000 Daltons.

3. The powder laundry detergent formulation of claim 2, containing 0.05 to 0.5 wt % of the polyethylene oxide having a weight average molecular weight, Mw, of 4,000,000 to 6,000,000.

4. The powder laundry detergent formulation of claim 1, containing 0.1 to 4 wt % of the poly(acrylic acid) having a weight average molecular weight, Mw, of 2,500 to 6,000.

5. The powder laundry detergent formulation of claim 4, containing 0.1 to 4 wt % of the poly(acrylic acid) having a weight average molecular weight, Mw, of 2,500 to 6,000.

6. The powder laundry detergent formulation of claim 5, wherein the detergent surfactant is a linear alkylbenzenesulfonate.

7. The powder laundry detergent formulation of claim 6, wherein the detergent surfactant is a linear C₁₀₋₂₀ alkylbenzenesulfonate.

8. A method of cleaning a textile, comprising:
providing a textile;
providing a wash water;
providing a rinse water;
providing a powder laundry detergent according to claim 1;
mixing the powder laundry detergent and the wash water to form a laundry liquor;
treating the textile with the laundry liquor; and
rinsing the textile with the rinse water.

9. The method of cleaning a textile of claim 8, wherein the textile is treated with the laundry liquor by hand-washing.

10. The method of claim 9, wherein the powder laundry detergent is mixed with the wash water at a weight ratio of 1:100 to 1:1,000.
